(19) United States
(12) Patent Application Publication
(10) Pub. No.: US 2015/0250025 A1
(43) Pub. Date: Sep. 3, 2015

(54) POWER MODULE AND INTERFACE MODULE FOR A HEATING CONTROLLER AND/OR REGULATOR AND A MODULAR SYSTEM FOR HEATING CONTROL AND/OR REGULATION

(71) Applicant: SIEMENS AKTIENGESELLSCHAFT, Munich (DE)

(72) Inventors: Christine BACH, Nuremberg (DE); Bernhard SCHMIDT, Nuremberg (DE); Reinhard SCHNEIDER, Bamberg (DE); Juergen STOLL, Fuerth (DE)

(73) Assignee: SIEMENS AKTIENGESELLSCHAFT, Munich (DE)

(21) Appl. No.: 14/635,295

(22) Filed: Mar. 2, 2015

(30) Foreign Application Priority Data
Feb. 28, 2014 (DE) 10 2014 203 657.7

(51) Int. Cl. H05B 1/02; H05B 3/00

(52) U.S. Cl. CPC H05B 1/0202; H05B 3/0019; H05B 1/023

(57) ABSTRACT

A housing has first and second communication interfaces, first and second voltage supply interfaces for voltage supply of the power module, power outputs, each connected to a heating element, and a power input electrically attached to a voltage supply for the heating elements. Enclosed by the housing is a power distribution device electrically connected on the input side to the power input and electrically connected on the output side via branches to the power outputs to supply these with electrical current. A switch element is provided in each branch. Switching states of the switch elements are controlled based on heating power reference values of the heating elements. Reference values are received via the first communication interface, with those intended for the power module being used to control the switch elements and those not intended for the power module being forwarded to the second communication interface.

### CROSS REFERENCE TO RELATED APPLICATIONS

This application is based on and hereby claims priority to German Application No. 10 2014 203 657.7 filed on Feb. 28, 2014, the contents of which are hereby incorporated by reference.

### BACKGROUND

The invention relates to a power module and an interface module, and to a system for heating control and/or regulation.

Industrially manufactured products are often thermally treated by heaters. In this case, even small variations in the heating process can severely compromise the product quality. In order to increase the quality of a heat-treated product, it is important that the required energy can be focused with great precision both temporally and spatially. This is achieved by special heating controllers and/or regulators, which ensure an extremely precise activation of heating elements. Ohmic consumer units in the form of radiant heaters, in particular infrared radiators, are often used as heating elements in this case.

For example, blow molding plants usually include radiant heater arrays for the purpose of heating preforms. The radiant heaters (infrared radiators) are electrically supplied by a heating controller and/or regulator, via a switch element which is connected into the voltage supply, and are controlled/regulated and monitored in respect of their power output.

In order to achieve this, provision is often made for the heating controller and/or regulator to receive reference values for the heating power of the attached heating elements from a supervisory controller and/or regulator, e.g. a stored programmable control (SPC), via a field bus. The reference values may take the form of absolute reference values or reference values which relate to a maximal power or a nominal power. For example, the power may relate to a heating power to be output, or an electrical power to be received by heating elements. These reference values are then used to derive activation signals for the switch elements by a predetermined control and/or regulation algorithm in the heating controller and/or regulator. However, the reference values may also be provided in the form of pulse packets or percentages of half-waves per time unit (e.g. per second), from which activation signals can be directly derived for the switch elements. The switching states of the switch elements and hence the heating powers of the heating elements can then be controlled or regulated by the activation signals. For the sake of simplicity and greater clarity, all of these reference values are referred to as “reference values for a heating power” in the following.

The activation of the switch elements and hence the control or regulation of the switching state or heating power can be effected e.g. by phase-angle control or half-wave control, with zero-power switching of the switch elements at the zero crossing. In this context, e.g. semiconductor switches (e.g. solid-state relays) are used as switch elements.

In this case, it is normal practice in industry to use heating controllers of compact construction, which have a housing of protection type IP 65 and can therefore be used in the immediate vicinity of the heating elements. The housing of these heating controllers has an attachment point for a non-proprietary industrial field bus such as e.g. PROFIBUS, for communication with a supervisory controller. The number of power outputs for heating elements is however limited to e.g. less than ten in this case. Supplying widely distributed heating elements by such a heating controller then involves significant cabling overheads. Alternatively, a separate heating controller can be provided for each of the distributed heating elements, though this increases the number of heating controllers and bus access points, as well as the control overheads in the supervisory controller.

Also conventionally used in industry are heating controllers include a communication and control part and one or more power sections for activating a plurality of heating elements. The communication and control part is used to communicate with a supervisory controller and to control the power sections. The power section controls the heating elements as specified by the communication and control part, possibly via separate switch elements. In this case, the communication and control part and the power sections are so arranged as to be immediately adjacent to each other, as separate assemblies in each case and without any particular protection type, or even combined in a shared system frame without any particular protection type. Consequently, these heating controllers cannot be situated in the immediate vicinity of the heating elements, but are usually arranged centrally in a control or switch cabinet, which then has a specific protection type. Here again, considerable cabling overheads are then involved when supplying widely distributed heating loads. Alternatively, provision can be made for each of the spatially distributed heating loads to have a separate heating controller, including in each case a communication and control part and one or more power sections, which must however then be arranged in a specially protected environment again (e.g. control cabinet). However, this significantly increases the number of heating controllers and bus access points, the control overheads in the supervisory controller, the wiring overheads for supplying the internal electronics of the components with a reliable extra-low voltage (e.g. 24 Vdc), and the overheads associated with the protection of the heating controllers.

### SUMMARY

Taking this as a starting point, one potential object is therefore to specify a solution by which it is possible in a flexible manner to control or regulate a larger number of heating elements, which may be situated in close proximity to each other or be widely distributed, using fewer components and requiring only modest cabling overheads. In addition, this solution is intended to ensure that the control/regulation overheads are kept at a low level in a supervisory control and/or regulation device.

The inventors propose a power module that has a housing which comprises
a first communication interface and a second communication interface, wherein the first communication interface can be connected to a second communication interface of another power module or of an interface module, and the second communication interface can be connected to a first communication interface of another power module,
a first voltage supply interface and a second voltage supply interface for the voltage supply of the power module, wherein the first voltage supply interface can be connected to a second voltage supply interface of another power module or of an interface module and the second voltage supply interface can be connected to a first voltage supply interface of another power module,
a plurality of power outputs to which a heating element can be electrically attached in each case, in particular a radiant heater in each case,
a power input, which can be electrically attached to a voltage supply for the heating elements, wherein the power module has, enclosed by the housing, components as follows:
a power distribution device, which is electrically connected on the input side to the power input and is electrically connected on the output side via a branch in each case to the power outputs in order to supply these with electrical current from the voltage supply,
a switch element in each of the branches,
a control and/or regulation unit, which is so configured as to control and/or regulate the switching state of the switch elements as a function of reference values for a heating power of the heating elements,
a communication unit, which is so configured as to receive reference values intended for the power module via the first communication interface and to transfer these to the control and/or regulation unit, and to forward reference values received via the first communication interface and not intended for the power module to the second communication interface.

The power module is therefore used for the actual control and/or regulation of the heating power of the attached heating elements by the switch elements that are assigned in each case. Each spatially dispersed heating element in a plant or each spatially dispersed group of heating elements can then be assigned one power module in each case. Since each power module has its own housing, it need not be arranged in a central control cabinet in this case, but can be arranged at the immediate location of a heating element. However, it is alternatively possible for the power modules to be so arranged as to be immediately adjacent, e.g. in a switch cabinet, i.e. it is therefore possible in a flexible manner to control and/or regulate a larger number of heating elements, which may be situated in close proximity to each other or widely distributed, by power modules which are arranged at the location of the heating element in each case.

The switch elements for the heating elements are also already integrated in the power module in this case, thereby eliminating the need to provide and install additional further separate switch elements with additional cabling for attaching the voltage supply, activation and monitoring.

The communication interfaces and the communication unit are used for communication with an interface module from which, in particular, reference values for the heating power can be received. The voltage supply interfaces are used for the internal voltage supply of the module. With regard to the internal communication and the internal voltage supply, a number of power modules can be connected in series via the communication interfaces and the voltage supply interfaces in this case, and this series connection can be connected on the input side to an interface module. The voltage supply and the specification of reference values for the heating power can then take place centrally via the interface module. By virtue of the series connection of the modules, the cabling overheads for most fields of application are reduced in comparison with a parallel connection.

However, the power supply of the heating elements need not be provided centrally via a series connection of interface module and power module(s), but can be provided in a decentralized manner at the immediate location of the heating elements in each case. This means that it is unnecessary to install a power cable to an interface module or an associated switch cabinet. In this way likewise, the cabling overheads can be kept at a low level.

Since the interface module can assume responsibility for the activation of a multiplicity of power modules and hence heating elements, a supervisory control and/or regulation device need only communicate with the interface module in order to specify reference values for the heating power, and not with all power modules, thereby allowing the control and/or regulation overheads in the supervisory control and/or regulation device to be kept at a low level.

The switch elements which are connected into the branches to the heating element outputs are preferably designed as semiconductor switches (e.g. solid-state relays). This allows precise low-loss control and/or regulation of the switching states and therefore of the heating power that is emitted by the heating elements, e.g. by phase-angle control or half-wave control.

In an advantageous embodiment, the power module also has at least one input in the housing for attaching a temperature sensor, and the control and/or regulation unit is so designed as to capture temperature information from this temperature sensor. For example, the temperature sensor can measure the temperature of a heating element or a heat-treated product. The housing can also have attachment points for a multiplicity of temperature sensors in this case, e.g. for one temperature sensor per heating element. The temperature information can then be used locally in the power module by the control and/or regulation unit to optimize the control and/or regulation of the heating power relative to a reference value. Alternatively, the control and/or regulation unit can transfer the temperature information to the communication unit. The communication unit is then so designed as to send this temperature information via one of the communication interfaces to an interface module. The choice of communication interface in this case is dependent on the configuration of the connection of the interfaces of the modules (e.g. linear or annular).

The temperature information can then be used either in the interface module or, after transfer from the interface module to a supervisory control and/or regulation device, by the supervisory control and/or regulation device to improve the control and/or regulation of the heating powers. The transfer of the temperature information to the interface module therefore takes place via the series connection of the power modules, thereby eliminating the need for separate cabling between the interface module and each of the power modules for this purpose.

In an advantageous embodiment of the power module, the housing also has at least one input for attaching a current and/or voltage sensor, and the control and/or regulation unit is so designed as to capture current and/or voltage information from this sensor. By the current and/or voltage sensor, it is possible to measure e.g. the current through a heating element, the voltage at a heating element, the current in the voltage supply of the heating elements or the voltage of the voltage supply of the heating elements. The housing can also have attachment points for a multiplicity of current and/or voltage sensors in this case, e.g. for one current and/or voltage sensor per heating element. The current and/or voltage information can then be used locally in the power module by the control and/or regulation unit to optimize the control and/or regulation of the heating power relative to a reference value. Alternatively or additionally, the control and/or regulation unit can transfer the current and/or voltage information to the communication unit. The communication unit is then so designed as to send this information via one of the communication interfaces to an interface module.

The current and/or voltage information can then be used either in the interface module or, after transfer from the interface module to a supervisory control and/or regulation device, by the supervisory control and/or regulation device to improve the control and/or regulation of the heating powers. The transfer of the current and/or voltage information to the interface module therefore takes place via the series connection of the power modules, thereby eliminating the need for separate cabling between the interface module and each of the power modules for this purpose.

The attachment points for the at least one temperature sensor and the at least one current and/or voltage sensor, and preferably also devices of the power module for capturing and preprocessing the measured values, can also be combined in a separate peripheral module which, when such measured values are required, can be mechanically and electrically connected to the power module (e.g. plugged onto or into the power module). This separate peripheral module may also comprise digital inputs for the capture of additional information (e.g. from an emergency cutoff device) by the control and/or regulation unit and/or digital outputs (e.g. for activating signal lights) by the control and/or regulation unit.

The control and/or regulation unit is also preferably so configured as to monitor the switch elements and line protection elements of the power distribution device, and to report errors to an interface module via the communication unit and one of the communication interfaces.

According to a further advantageous embodiment, the power module has a measuring device for measuring a voltage that is present at the power input, and the control and/or regulation unit is connected to the measuring device and is so configured as to use the measured value of the voltage that is present at the power input to correct the reference values which have been received from the communication unit or derived therefrom, in order to compensate for voltage fluctuations.

According to a further advantageous embodiment of the power module the housing has at least one fan output for the electrical attachment of a fan,
the power distribution device is electrically connected on the output side via a branch to the fan output in order to supply this with electrical current from the voltage supply, wherein a switch element is connected into the branch,
the communication unit is so configured as to receive fan control commands and/or fan reference values intended for the power module via the first communication interface and to transfer these to the control and/or regulation unit, and to forward fan control commands and/or fan reference values received via the first communication interface and not intended for the power module to the second communication interface,
the control and/or regulation unit is so configured as to control and/or regulate the switching state of the switch element which is connected into the branch to the fan output as a function of the fan control commands and/or fan reference values received from the communication unit.

This means that both all of the components required for the supply and activation of the heating elements, and all of the components required for the supply and activation of the fan, are integrated into a single unit in the form of the power module. It is therefore possible to make significant savings in terms of wiring overheads and space in the plant, particularly in the main switch cabinet in this case, and in terms of associated installation overheads. For example, it is possible to dispense with long supply lines from the main switch cabinet to the fan. Even the fuse protection of these lines in the main switch cabinet can be omitted, as this can likewise be integrated into the power module.

According to a further advantageous embodiment, the housing of the power module is designed to have a protection type of IP 65 or better, and can therefore be arranged in a harsh industrial environment at the immediate location of the heating elements.

For ease of installation, the interfaces and inputs and outputs are preferably designed as plug connections.

The inventors also propose an interface module for a heating controller and/or regulator has:
a first communication interface for the attachment to a supervisory communication system,
a second communication interface, which can be connected to a first communication interface (3) of a power module (1),
a first voltage supply interface (35), which can be connected to an external voltage supply (39),
a second voltage supply interface, which can be connected to a first voltage supply interface of a power module,
a communication and control unit, which is so designed as to
a) receive reference values via the first communication interface, for the heating power of heating elements,
b) assign these reference values to power modules,
c) send these reference values or reference values derived therefrom, with information indicating the assigned power module in each case, to the power modules via the second communication interface.

The interface module is therefore used as a central interface for the activation of a multiplicity of power modules by a supervisory communication system, e.g. from a supervisory control and/or regulation device. It can provide an internal voltage supply for a multiplicity of power modules from a central point via its voltage supply output, wherein the cabling overheads are then modest for the voltage supply via the series connection of the voltage supply interfaces of the power modules. It also allows reference values for the switch elements to be generated and distributed from a central point via its second communication interface, wherein the cabling overheads are then modest for the transmission of the reference values via the series connection of the communication interfaces of the power modules. The reference values can be forwarded to the power modules without further conversion in this case, but provision can also be made for initial preprocessing which results in modified reference values being derived from the originally received reference values. In particular, when deriving the modified reference values, it is possible in this way to allow for time shifts when switching on the heating elements of various modules, in order to limit the starting currents.

The information indicating the assigned power module in each case may be provided e.g. by assigning the power modules to addresses when they first become operational.

According to an advantageous embodiment, the interface module has an error memory and the communication and control unit is so designed as to store error reports received from power modules in this error memory. The error reports of all power modules and also of the interface module can then be read out from this central point (e.g. by a supervisory control and/or regulation device) and analyzed.

The communication and control unit is advantageously so designed as to take temperature information and/or voltage information received from power modules into account when deriving reference values, and/or to send said temperature information and/or voltage information to a supervisory control and/or regulation device via the first communication interface. It is thus possible to improve the control and/or regulation of the heating power of the heating elements relative to the reference values.

For ease of installation, the interfaces of the interface module are preferably designed as plug connections.

According to a further advantageous embodiment, the housing of the interface module is designed to have a protection type of IP 65 or better, and can therefore be arranged outside of a switch cabinet in a harsh industrial environment at the immediate location of the heating elements.

In an advantageous embodiment, the interface module also has at least one input on the housing for attaching a temperature sensor, and the communication and control unit is so designed as to capture temperature information from this temperature sensor. For example, the temperature sensor can measure the temperature of a heating element or a heat-treated product. The housing can also have attachment points for a multiplicity of temperature sensors in this case, e.g. for one temperature sensor per heating element. The temperature information can then be used locally in the interface module by the communication and control unit to optimize the control and/or regulation of the heating power relative to a reference value. Alternatively or additionally, the communication and control unit can transfer the temperature information via the second communication interfaces to the power modules, where it can then be used to optimize the control and/or regulation of the heating power. Alternatively or additionally, the communication and control unit can transfer the temperature information via the first communication interface to a supervisory control and/or regulation device, where it can then be used to optimize the control and/or regulation of the heating power.

In an advantageous embodiment of the interface module, the housing also has at least one input for attaching a current and/or voltage sensor and the communication and control unit is so designed as to capture current and/or voltage information from this sensor. By the current and/or voltage sensor, it is possible to measure e.g. the current through a heating element, the voltage at a heating element, the current in the voltage supply of the heating elements or the voltage of the voltage supply of the heating elements. The housing can also have a attachment points for a multiplicity of current and/or voltage sensors in this case, e.g. for one current and/or voltage sensor per heating element. The current and/or voltage information can then be used locally in the interface module by the communication and control unit to optimize the control and/or regulation of the heating power relative to a reference value. Alternatively or additionally, the communication and control unit can transfer the current and/or voltage information via the second communication interface to the power modules, where it can then be used to optimize the control and/or regulation of the heating power. Alternatively or additionally, the communication and control unit can transfer the current and/or voltage information via the first communication interface to a supervisory control and/or regulation device, where it can then be used to optimize the control and/or regulation of the heating power.

The attachment points for the at least one temperature sensor and the at least one current and/or voltage sensor, and preferably also devices of the interface module for capturing and preprocessing the measured values, can also be combined in a separate peripheral module which, when such measured values are required, can be mechanically and electrically connected to the interface module (e.g. plugged onto or into the interface module). This separate peripheral module may also comprise digital inputs for the capture of additional information (e.g. from an emergency cutoff device) by the communication and control unit and/or digital outputs (e.g. for activating signal lights) by the communication and control unit.

The additional peripheral module is preferably so designed as to be identical to the additional peripheral module that can be connected to the power modules, and the interface on the side of the interface module is also preferably so designed as to be identical to that on the side of the power module. The additional peripheral modules can then be connected in a flexible manner to both the interface modules and the power modules.

A proposed system for heating control and/or regulation comprises at least one power module as described above and an interface module as described above, wherein the modules are connected in series starting from the interface module via their voltage supply interfaces (for the purpose of forwarding an internal supply voltage) and via their communication interfaces (for the purpose of forwarding reference values for a heating power of heating elements).

In this case, the at least one power module is arranged in the immediate vicinity of heating elements which it is to control and/or regulate, and spatially distant or separate from the interface module.

The connection lines between two of the series-connected modules are preferably combined to form a single cable which is preferably screened and preferably of a plug-in type.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block schematic diagram of a simple embodiment variant of a power module;

FIG. 2 shows a block schematic diagram of a power module with additional inputs/outputs;

FIG. 3 shows a block schematic diagram of a simple embodiment variant of an interface module;

FIG. 4 shows a block schematic diagram of an interface module with additional inputs/outputs; and

FIG. 5 shows a block schematic diagram of a system according to the proposals for heating control and/or regulation.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

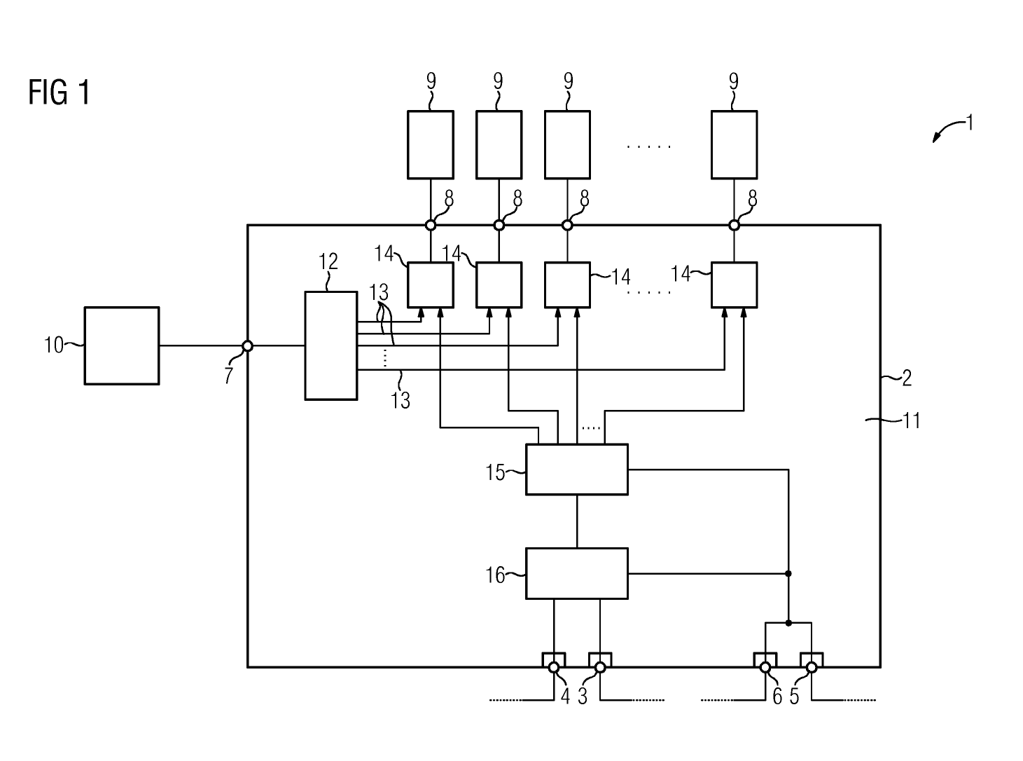

A power module 1 for heating control and/or regulation as illustrated in FIG. 1 has a housing 2 which comprises a first communication interface 3 and a second communication interface 4, a first voltage supply interface 5 and a second voltage supply interface 6, a power input 7 and a plurality of (e.g. nine) power outputs 8.

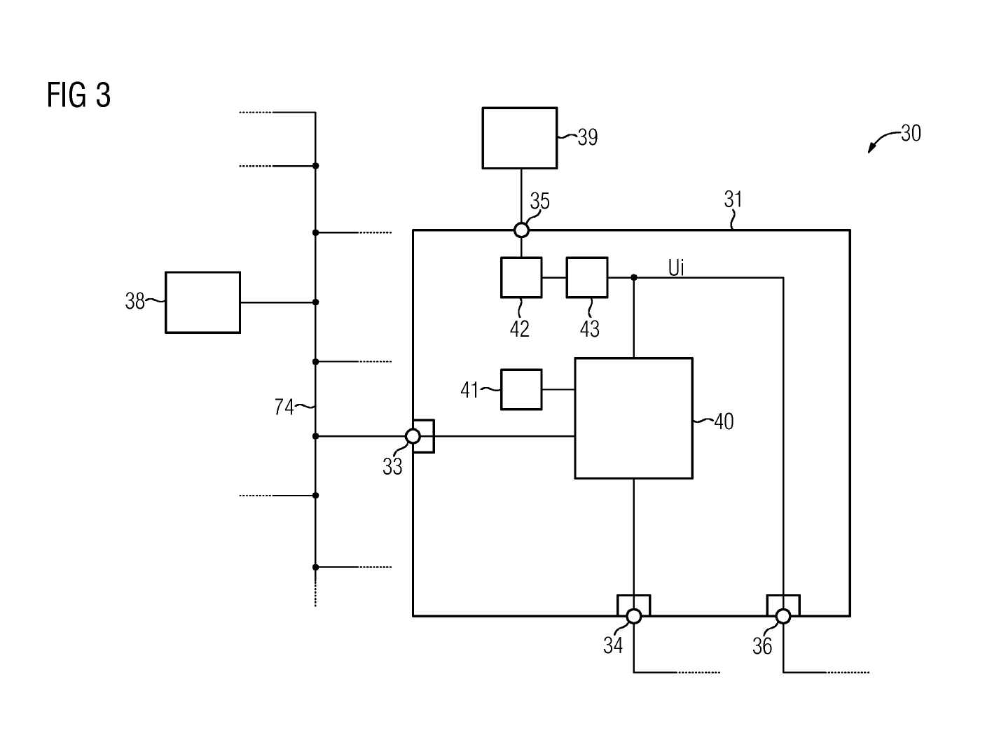

The first communication interface 3 can be connected to a second communication interface of another power module or of an interface module as shown in FIG. 3, and the second communication interface 6 can be connected to a first communication interface of another power module.

The first voltage supply interface 5 and the second voltage supply interface 6 are used for the (internal) voltage supply of the power module 1 (e.g. the module electronics) with a DC voltage of e.g. 24 Vdc, wherein the first voltage supply interface 5 can be connected to a second voltage supply interface of another power module or of an interface module as shown in FIG. 3, and the second voltage supply interface 6 can be connected to a first voltage supply interface of another power module.

A heating element 9, in particular a radiant heater in each case, can be electrically attached to the power outputs 8 in each case. The electrical power of each radiant heater is between 0.5 and 5 kW, for example.

The power input 7 can be electrically attached to an external voltage supply 10 (e.g. having a nominal voltage of 400 Vac) for the heating elements 9.

The power module 1 also has a power distribution device 12 comprising line protection elements (not shown in more detail), which is electrically connected on the input side to the power input 7 and is electrically connected on the output side via a branch 13 in each case to the power outputs 8 in order to supply these with electrical current from the voltage supply 10. A switch element 14 is connected into each of the branches 13. A switch element 14 preferably takes the form of a semiconductor switch (e.g. so-called “solid-state relay”).

The power module 1 also has a control and/or regulation unit 15 and a communication unit 16.

The control and/or regulation unit 15 is so configured as to control and/or regulate the switching state of the switch elements 14 as a function of reference values for the heating power.

The reference values may take the form of absolute reference values, for example, or reference values for the heating power which relate to a maximal power or a nominal power. Activation signals for the switch elements 14 are derived from these reference values by the control and/or regulation unit 15 by a predetermined control and/or regulation algorithm. However, the reference values may also take the form of pulse packets or percentage values of half-waves per second, from which activation signals can then be directly derived for the switch elements 14. The switching states of the switch elements 14 and hence the heating power of the heating elements 9 can then be controlled and/or regulated by the activation signals.

The activation of the switch elements 14 and hence the control or regulation of the switching state or heating power can be effected by phase-angle control or half-wave control, for example.

The communication unit 16 is so configured as to receive reference values intended for the power module 1 via the first communication interface 3 and to transfer these to the control and/or regulation unit 15, and to forward reference values received via the first communication interface 3 and not intended for the power module 1 to the second communication interface 4.

The power distribution device 12, the branches 13, the switch elements 14, the control and/or regulation unit 15 and the communication unit 16 are enclosed and therefore protected by the housing 2. The housing is preferably designed to have a protection type of IP 65 or better, and the power module 1 is therefore suitable for industrial use in the field under harsh environmental conditions.

In this case, the control and/or regulation unit 15 may also be so designed as to monitor the switch elements 14 and any line protection elements such as e.g. fuses (not shown in more detail) of the power distribution device 12, and to transfer error information to the communication unit 16. The communication unit 16 is then so designed as to send this error information to an interface module via one of the communication interfaces 3, 4.

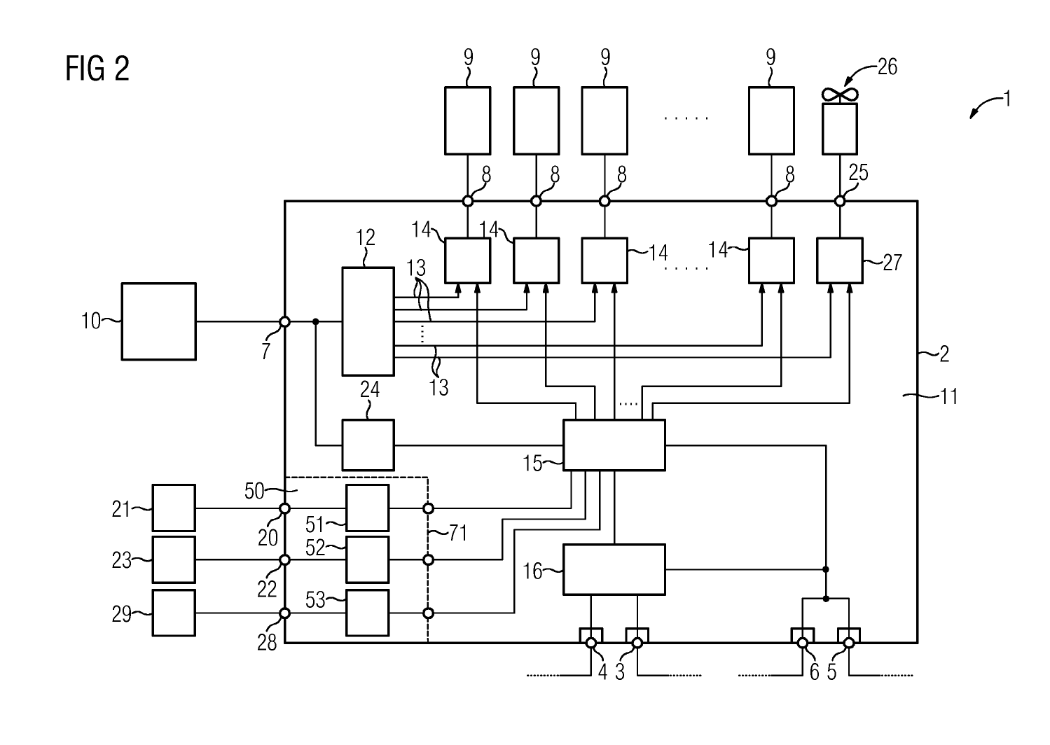

As illustrated in FIG. 2, the power module 1 may optionally feature additional inputs, components and functionalities.

For example, the power module 1 may allow actual values of temperatures, e.g. the temperature of one or more heating elements 9 or of a heat-treated product, to be taken into account during the control and/or regulation of the heating power of the heating elements 9 relative to a reference value. For this purpose, the housing 2 may comprise at least one input 20 for attaching a temperature sensor 21. The control and/or regulation unit 15 is then preferably so designed as to capture temperature information from this temperature sensor 21. This temperature information can then be used locally by the control and/or regulation unit 15 in the power module 1 to control and/or regulate the heating power, or transferred to the communication unit 16, which sends this temperature information to an interface module via one of the communication interfaces 3, 4.

The power module 1 may also allow actual values of currents or voltages, e.g. of heating elements 9 or of the voltage supply 10, to be taken into account during the control and/or regulation of the heating power of the heating elements 9 relative to a reference value. For this purpose, the housing 2 comprises at least one input 22 for attaching a current and/or voltage sensor 23 which measures a voltage that is present at a heating element 9 and/or a current that is flowing through the heating element 9, and the control and/or regulation unit 15 is then preferably so designed as to capture current and/or voltage information from this sensor 23. This current and/or voltage information can then be used locally by the control and/or regulation unit 15 in the power module 1 to control and/or regulate the heating power, or transferred to the communication unit 16, which sends this current and/or voltage information to an interface module via one of the communication interfaces 3, 4.

The attachment points 20, 22 for the at least one temperature sensor 21 and the at least one current and/or voltage sensor 23, and preferably also associated devices 51, 52 for capturing and preprocessing the measured values, can be combined in a separate peripheral module 50 which, when such measured values are required, can be mechanically and electrically connected to (e.g. plugged onto or into) the power module 2 via an interface 71. This separate peripheral module 50 may also comprise digital inputs for the capture of additional information by the communication and control unit 15 and/or digital outputs (e.g. for activating signal lights) by the control and/or regulation unit 15. A digital input 28 for capturing an emergency cutoff signal from an emergency cutoff device 29, with an associated device 53 for capturing and preprocessing the input signal, are shown by way of example.

The power module 1 may also compensate for fluctuations in the voltage at the power input 7. For this purpose, the power module 1 may comprise a measuring device 24 for measuring the voltage which is present at power input 7. The control and/or regulation unit 15 is then connected to the measuring device 24 and is so configured as to use the measured value of the voltage that is present at the power input 7 to correct the reference values which have been received from the communication unit 16 or derived therefrom, in order to compensate for voltage fluctuations.

The power module 1 may also provide activate one or more fans 26. The housing 2 may then comprise at least one fan output 25 for the electrical attachment of a fan 26. In this case, the power distribution device 12 is electrically connected on the output side via a branch 13 to the fan output 25 in order to supply this with electrical current from the voltage supply 10, wherein a switch element 27 is connected into the branch 13. The switch element 27 is preferably a semiconductor switch (e.g. a so-called “solid-state relay”) or alternatively an electromechanical protection.

The communication unit 16 is then so configured as to receive fan control commands and/or fan reference values intended for the power module 1 via the first communication interface 3 and to transfer these to the control and/or regulation unit 15, and to forward fan control commands and/or fan reference values received via the first communication interface 3 and not intended for the power module 1 to the second communication interface 4. The control and/or regulation unit 15 is then so configured as to control and/or regulate the switching state of the switch element 27, which is connected into the branch 13 to the fan output 25, as a function of the fan control commands and/or fan reference values received from the communication unit 16.

An interface module 30 shown in FIG. 3 for heating control and/or regulation has a housing 31 which comprises a first communication interface 33, a second communication interface 34, a first voltage supply interface 35 and a second voltage supply interface 36.

The first communication interface 33 is used for attaching to a supervisory non-proprietary communication system 74 such as e.g. PROFIBUS or PROFINET, and for communicating with a supervisory control and/or regulation device 38 which is attached thereto. The second communication interface 34 can be connected to a first communication interface 3 of a power module 1 (see FIGS. 1 and 2).

The first voltage supply interface 35 can be connected to an external voltage supply 39 (e.g. 230 Vac).

The second voltage supply interface 36 can be connected to a first voltage supply interface 5 of a power module 1 (see FIGS. 1 and 2).

The interface module 30 has, enclosed by the housing 31, a communication and control unit 40 which is so designed as to:
a) receive reference values via the first communication interface 33, for the control and/or regulation of the heating power of heating elements 9 (see FIGS. 1 and 2),
b) assign these reference values to power modules 1 and their power outputs 8 (see FIGS. 1 and 2),
c) send these reference values or reference values derived therefrom, with information indicating the assigned power module 1 in each case and the assigned power output 8 of said power module 1 in each case, to the power modules 1 via the second communication interface 34.

The assignment of the reference values to the power modules 1 can be effected using addresses which are defined for the power modules 1 when they become operational.

In addition, the communication and control unit 40 can be so designed as to likewise:
a) receive fan control commands and/or fan reference values via the first communication interface 33, for the control and/or regulation of fans 26 (see FIG. 2),
b) assign these fan control commands and/or fan reference values to power modules 1 and their fan outputs 25 (see FIG. 2),
c) send these fan control commands and/or fan reference values, or control commands or reference values derived therefore, with information indicating the assigned power module 1 in each case and the assigned fan output 25 of said power module 1 in each case, to the power modules 1 via the second communication interface 34.

The interface module 30 also has an error memory 41 and the communication and control unit 40 is so designed as to store error information which is received from power modules 1 via the second communication interface 34 and error information which is generated locally in this error memory 41.

The communication and control unit 40 is moreover so designed as to use temperature information, current and/or voltage information or other input signals (e.g. emergency cutoff signal) which are received from power modules 1 via the second communication interface 34, either locally to optimize the control and/or regulation of the heating power or to generate control commands for the power modules 1 (e.g. commands for switching heating elements in or out, activation commands for digital outputs, e.g. for signal lights), or to send these via the first communication interface 33 and the communication system 37 to the supervisory control and/or regulation device 38, where they can then be used to optimize the control and/or regulation of the heating power or to generate control commands.

The interfaces 33, 34, 35, 36 are designed as plug connections in this case.

The housing 31 is preferably designed to have a protection type of IP 65 or better.

The voltage supply 39 having a nominal voltage of 24 Vdc is used to provide a supply voltage Ui for the communication and control unit 40 and for the electronics of a plurality of (e.g. a maximum of eight) power modules 1. For this purpose, the voltage supply 39 is connected via the first voltage supply interface 35, a filter/protection circuit 42 and possibly a DC/DC converter 44 to both the communication and control unit 40 and the second voltage supply interface 36.

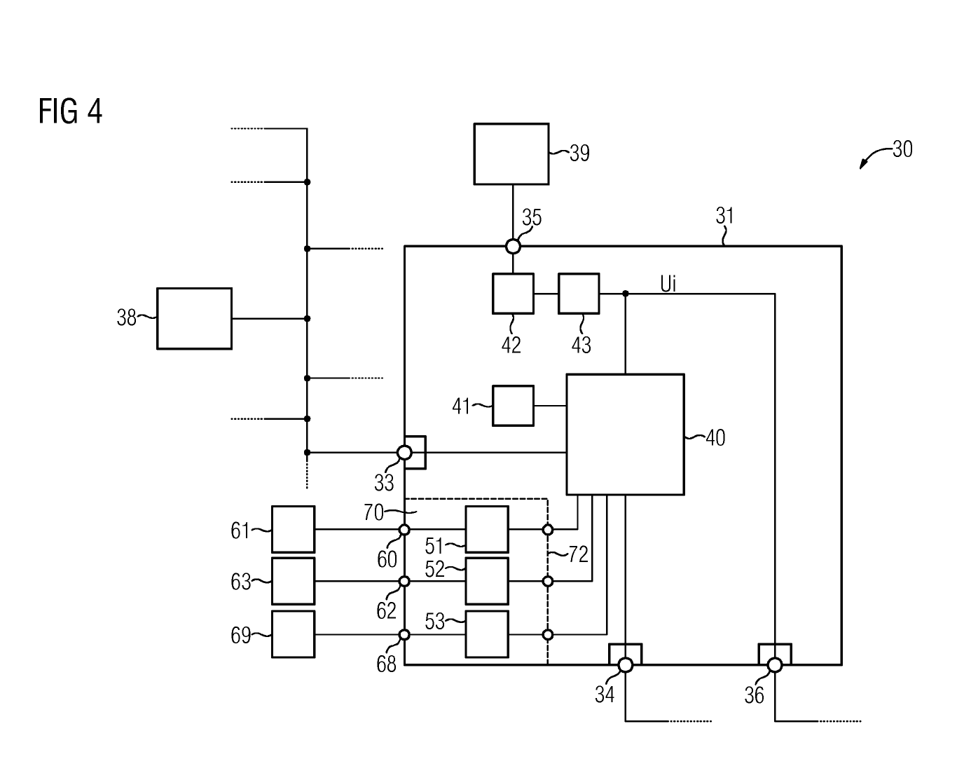

As illustrated in FIG. 4, the interface module 30 may optionally feature additional further inputs, outputs, components and functionalities.

For example, the interface module 30 may allow actual values of temperatures, e.g. the temperature of one or more heating elements 9 or of a heat-treated product, to be taken into account during the control and/or regulation of the heating power of the heating elements 9 relative to a reference value. For this purpose, the housing 31 may comprise at least one input 60 for attaching a temperature sensor 61. The communication and control unit 40 is then preferably so designed as to capture temperature information from this temperature sensor 21. This temperature information can then be used locally by the communication and control unit 40 to control and/or regulate the heating power (e.g. by adapting reference values), or transferred via the communication interface 34 to the power modules 1, which use this temperature information to control and/or regulate the heating power.

The interface module 30 may also allow actual values of currents or voltages, e.g. of heating elements or of the voltage supply, to be taken into account during the control and/or regulation of the heating power of the heating elements 9 relative to a reference value. For this purpose, the housing 31 comprises at least one input 62 for attaching a current and/or voltage sensor 63 which measures a voltage that is present at a heating element 9, and the communication and control unit 40 is then preferably so designed as to capture current and/or voltage information from this sensor 63. This current and/or voltage information can then be used locally by the communication and control unit 40 to control and/or regulate the heating power (e.g. by adapting reference values), or transferred via the communication interface 34 to the power modules 1, where it is used to control and/or regulate the heating power.

The attachment points 60, 62 for the at least one temperature sensor 61 and the at least one current and/or voltage sensor 63, and preferably also associated devices 51, 52 for capturing and preprocessing the measured values, can be combined in a separate peripheral module 70 which, when such measured values are required, can be mechanically and electrically connected to the interface module 30 (e.g. plugged onto or into the interface module) via an interface 72. This separate module 70 may also comprise digital inputs for the capture of additional information by the communication and control unit 40 and/or digital outputs (e.g. for activating signal lights) by the communication and control unit 40. A digital input 68 for capturing an emergency cutoff signal from an emergency cutoff device 69, with an associated device 53 for capturing and preprocessing the input signal, are shown by way of example.

As illustrated here, the additional peripheral module 70 is preferably so designed as to be identical to the additional peripheral module 50 that can be connected to the power modules 1, and the interface 72 on the side of the module 70 is also preferably so designed as to be identical to the interface 71 on the side of the module 50. The additional modules 50, 70 can then be connected in a flexible manner to both the interface modules 30 and the power modules

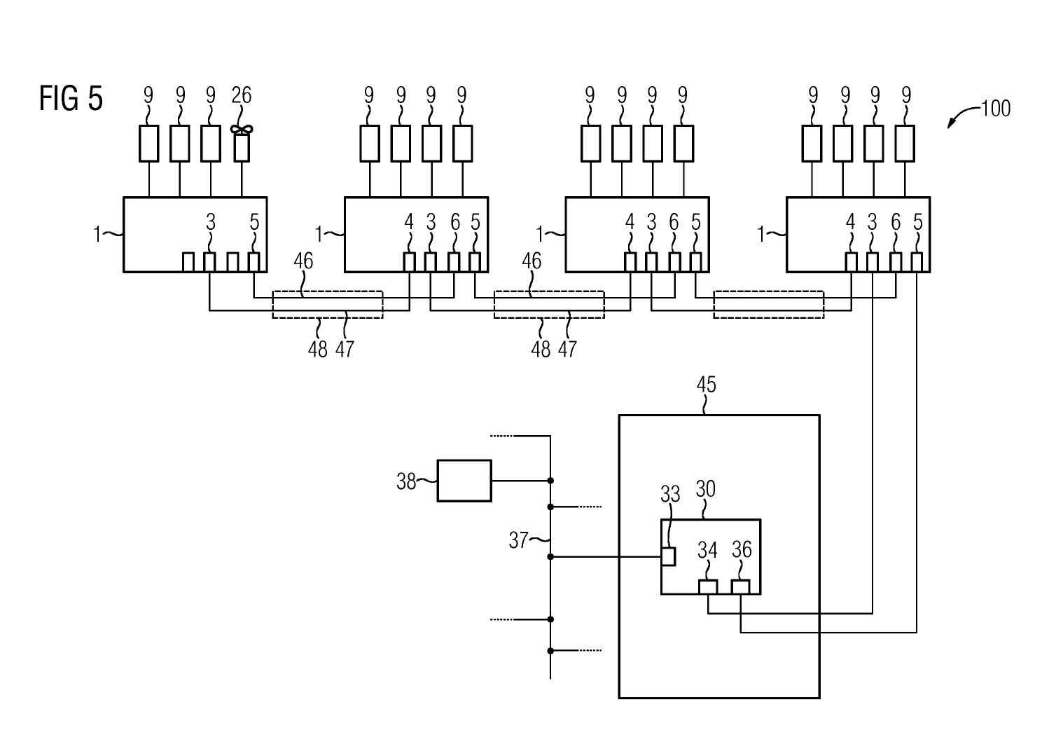

A system 100 for heating control and/or regulation as shown in FIG. 5 comprises an interface module 30 and a plurality of power modules 1, wherein said modules 1, 30 are connected in series starting from the interface module 30 via their voltage supply interfaces 36 and 5, 6 respectively (for the purpose of forwarding the supply voltage Ui) and via their communication interfaces 34 and 3, 4 respectively (for the purpose of forwarding control commands and reference values for heating powers of the heating elements 9, for forwarding fan control commands or reference values).

The power modules 1 in this case can be so arranged in the field as to be spatially distant from each other and from the interface module 30, and in the immediate vicinity of the heating elements 9 and/or fans 26 which they are to control and/or regulate. The power modules 1 in this case can be arranged in a control or switch cabinet or, in the case of a housing 2 which has a sufficiently high protection type, also outside of a control or switch cabinet.

The interface module 30 can be arranged in a control or switch cabinet 45 or, in the case of a housing 31 which has a high protection type, also in the vicinity of heating elements 9 and/or fans 26 in the field.

The interface module 30 and the first subsequent power module 1 can also be arranged together in a control or switch cabinet 45, and the other power modules 1 arranged in the vicinity of heating elements 9 and/or fans 26 in the field.

However, it is also possible in a flexible manner to arrange the modules immediately adjacent to each other if necessary, e.g. on a shared top hat rail.

In this case, depending on the requirements and spatial arrangement of the heating elements or fan, it is also possible in a flexible manner to form combinations of one or more interface modules, each of which has one or more power modules connected in series thereto.

The connection lines 46, 47 between two series connected modules are preferably combined to form a single cable 48 which is preferably of a plug-in type.

In order to prevent EMC interference in the cable 48, which can occur in the case of phase-angle control in a power module 1, for example, the cable is preferably screened. In order to further increase the EMC resistance, additional protection mechanisms such as e.g. CRC checksums can be used when transferring data on the lines 47.

The second communication interfaces 34 of the interface module and the first and second communication interfaces 3, 4 of the power modules 1 can be designed as standard interfaces, e.g. as per the RS485 standard. The communication to the supervisory control and/or regulation device 38 preferably takes place via a non-proprietary communication system 37 such as PROFIBUS or PROFINET, for example. The communication between the interface module 30 and the power modules 1 can also take place using a proprietary protocol.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A power module, comprising:
a first communication interface and a second communication interface, the first communication interface being configured to be connected to a second communication interface of another power module or connected to an interface module, the second communication interface being configured to be connected to a first communication interface of another power module;
a first voltage supply interface and a second voltage supply interface configured to supply voltage for the power module, the first voltage supply interface being configured to be connected to a second voltage supply interface of another power module or connected to a second voltage supply interface of an interface module, the second voltage supply interface being configured to be connected to a first voltage supply interface of another power module;
a plurality of power outputs, each of the power outputs being configured to be electrically connected to a heating element;
a power input that is configured to be electrically connected to a voltage supply for the heating elements;
a power distribution device that is electrically connected on an input side to the power input and is electrically connected on an output side to each of the plurality of the power outputs in order to supply each of the power outputs with electrical current from the voltage supply;
a plurality of branches, each branch being provided between the power distribution device and one of the plurality of power outputs;
a plurality of switch elements, each switch element being connected into one of the branches;
a controller configured to control a switching state of each of the switch elements as a function of reference values for a heating power of the heating elements; and
a communication unit configured to receive reference values intended for the power module via the first communication interface and to transfer the received reference values to the controller, and to forward reference values received via the first communication interface and not intended for the power module to the second communication interface.

2. The power module as claimed in claim 1, further comprising:
at least one input configured to attach a temperature sensor to the power module, and
the controller is configured to capture temperature information from the temperature sensor.

3. The power module as claimed in claim 1, further comprising:
at least one input configured to attach a current/voltage sensor to the power module, and
the controller is configured to capture voltage information from the current/voltage sensor.

4. The power module as claimed in claim 1, wherein
the controller is configured to monitor the switch elements and line protection elements of the power distribution device, and to transfer error information to the communication unit, and
the communication unit is configured to send the error information to the interface module via the first communication interface or the second communication interface.

5. The power module as claimed in claim 1, further comprising:
a measuring device that is connected to the controller and that is configured to measure a voltage that is present at the power input, wherein
the controller is configured to use the measured voltage that is present at the power input to correct the reference values that have been received from the communication unit or reference values that have been derived from the reference values that have been received from the communication unit, in order to compensate for voltage fluctuations.

6. The power module as claimed in claim 1, further comprising:
at least one fan output configured to be electrically connected to a fan,
the power distribution device is electrically connected on the output side to the fan output via a fan branch in order to supply the fan output with electrical current from the voltage supply, a fan switch element being connected into the fan branch,
the communication unit is configured to receive fan control commands and/or fan reference values intended for the power module via the first communication interface and to transfer the received fan control commands and/or fan reference values to the controller, and to forward fan control commands and/or fan reference values received via the first communication interface and not intended for the power module to the second communication interface, and
the controller is configured to control a switching state of the fan switch element that is connected into the fan branch to the fan output as a function of the fan control commands and/or fan reference values received from the communication unit.

7. The power module as claimed in claim 1, wherein a housing of the power module has a protection type of IP 65 or better.

8. The power module as claimed in claim 1, wherein the first communication interface, the second communication interface, the first voltage supply interface, the second voltage supply interface, the power input, and the power outputs are plug connections.

9. An interface module, comprising:
a first communication interface configured to connect the interface module to a supervisory communication system;
a second communication interface configured to be connected to a first communication interface of a first power module of a plurality of power modules;
a first voltage supply interface configured to be connected to an external voltage supply;
a second voltage supply interface configured to be connected to a first voltage supply interface of the first power module or a second power module of the plurality of power modules; and
a communication and control unit configured to:
receive reference values for control of a heating power of heating elements via the first communication interface,
assign the received reference values to the plurality of power modules, and
send the received reference values or reference values derived from the received reference values, with information indicating an assigned power module, to the plurality of power modules via the second communication interface.

10. The interface module as claimed in claim 9, further comprising:
an error memory, wherein the communication and control unit is configured to store the error information received from the plurality of power modules in the error memory.

11. The interface module as claimed in claim 9, wherein the communication and control unit is configured to send temperature information and/or voltage information received from the plurality of power modules to a supervisory control and/or regulation device via the first communication interface.

12. The interface module as claimed in claim 9, wherein the first communication interface, the second communication interface, the first voltage supply interface, and the second voltage supply interface are plug connections.

13. The interface module as claimed in claim 9, wherein a housing of the interface module has a protection type IP 65 or better.

14. A system, comprising:
at least one power module as claimed in claim 1; and
an interface module, the interface module comprising:
a first communication interface configured to connect the interface module to a supervisory communication system;
a second communication interface configured to be connected to the first communication interface of the at least one power module;
a first voltage supply interface configured to be connected to an external voltage supply;
a second voltage supply interface configured to be connected to the first voltage supply interface of the at least one power module; and
a communication and control unit configured to:
receive the reference values for the control of the heating power of the heating elements via the first communication interface,
assign the received reference values to the at least one power module, and
send the received reference values or reference values derived from the received reference values, with information indicating an assigned power module, to the at least one power module via the second communication interface,
wherein the at least one power module and the interface module are connected in series starting from the interface module via the first voltage supply interface of the at least one power module and the second voltage supply interface of the interface module for forwarding a supply voltage and via the first communication interface of the at least one power module and the second communication interface of the interface module for forwarding the reference values for the control of the heating power of the heating elements.

15. The system as claimed in claim 14, wherein the at least one power module is arranged as to be spatially distant from the interface module and in the immediate vicinity of the heating elements.

16. The system as claimed in claim 14, wherein connection lines between the series-connected at least one power module and the interface module are combined to form a single cable.

17. The system as claimed in claim 14, wherein
the system comprises at least first and second power modules, and
the first power module is connected in series with the second power module via the second voltage supply interface of the first power module and the first voltage supply interface of the second power module and via the second communication interface of the first power module and the first communication interface of the second power module.

18. The power module as claimed in claim 2, wherein the at least one input is a plug connection.

19. The power module as claimed in claim 3, wherein the at least one input is a plug connection.

20. The power module as claimed in claim 6, wherein the at least one fan output is a plug connection.
